(19) United States
(12) Patent Application Publication
(10) Pub. No.: US 2012/0176301 A1
(43) Pub. Date: Jul. 12, 2012

(54) DISPLAY DEVICE

(76) Inventors: Gary Gibson, Palo Alto, CA (US); Stephen Kitson, Alveston (GB); Timothy Taphouse, Thornbury (GB)

(21) Appl. No.: 13/387,061

(22) PCT Filed: Sep. 30, 2009
(86) PCT No.: PCT/US09/59062

§ 371 Date: Mar. 26, 2012

(51) Int. Cl. G09G 3/36; H05B 33/12

(52) U.S. Cl. 345/88; 313/498

(57) ABSTRACT

A display device includes a plurality of pixel components, each of which includes a first electro-optic layer positioned between a first pair of electrodes, in which the first electro-optic layer is configured to selectively absorb light in a first specified wavelength, a second electro-optic layer positioned between a second pair of electrodes, in which the second electro-optic layer is configured to selectively absorb light in a second specified wavelength band and to convert the absorbed light to at least a portion of the first specified wavelength band, in which the first electro-optic layer and the second electro-optic layer are arranged in a stack with respect to each other.

### RELATED APPLICATIONS

The present application contains some common subject matter with U.S. patent application Ser. No. 12/325,601, entitled “Reflective Display”, filed on Dec. 1, 2008 by Adrian Geisow and Stephen Kitson, and U.S. patent application Ser. No. 11/629,692, entitled “Liquid Crystal Display Device”, filed on Dec. 12, 2007 by Susanne Klein and Adrian Geisow, the disclosures of which are incorporated by reference in their entireties.

### BACKGROUND

Guest-host liquid crystal display devices operate by reorienting a dichroic dye (the guest), which is dissolved in a liquid crystal (LC) host. The orientation of the anisotropy in the guest molecules' optical absorption is determined by the orientation of the host. In some cases, the axes for optical anisotropy may be different than the physical axes of the guest molecules so that the absorption axes may be at an angle to the direction of the LC host molecules. Displays based on conventional guest-host LC systems often face limitations in terms of the brightness and contrast they can attain. As with many color reflective display technologies, the brightness of these types of displays is limited, in part, due to absorption and stray reflection in the numerous electrode and substrate layers that are required to achieve bright, full color, which often requires the stacking of three active cells for independent control of red, green, and blue colors. For instance, both brightness and contrast are limited by the dichroic ratios of the absorbing species (anisotropic dye), the angular dependence of the incident light, and the degree with which the dichroic absorbers can be oriented by the LC.

Some of the off-normal light incident on a guest-host layer that is intended to be in the non-absorbing state will be absorbed because the light's electric field is not perpendicular to the absorbing transition moment of the absorber. For instance, in the non-absorbing state, the LC and the anisotropic dye are aligned vertically with respect to the guest-host layer. Even some of the normal incident light can be absorbed if the LC does not orient all of the absorbing species properly. As LC is liquid, the anisotropic dye (guest) molecules are not always perfectly aligned, which limits the dynamic range of guest-host effects, and thus negatively impacts brightness.

### BRIEF DESCRIPTION OF THE DRAWINGS

Features of the present invention will become apparent to those skilled in the art from the following description with reference to the figures, in which:

FIG. 1A shows a diagram of a pixel component of a display device, according to an embodiment of the present invention;

FIG. 1B shows a diagram of a pixel component of a display device, according to another embodiment of the present invention;

FIG. 2 shows a diagram of a first sub-pixel component and a second sub-pixel component of a display device, according to an embodiment of the present invention; and

FIG. 3 illustrates a flowchart of a method of displaying an image on a display device, according to an embodiment of the present invention.

### DETAILED DESCRIPTION

For simplicity and illustrative purposes, the present invention is described by referring mainly to exemplary embodiments. In the following description, numerous specific details are set forth to provide a thorough understanding of the embodiments. However, it will be apparent to one of ordinary skill in the art that the present invention may be practiced without limitation to these specific details. In other instances, well known methods and structures have not been described in detail to avoid unnecessarily obscuring the description of the embodiments.

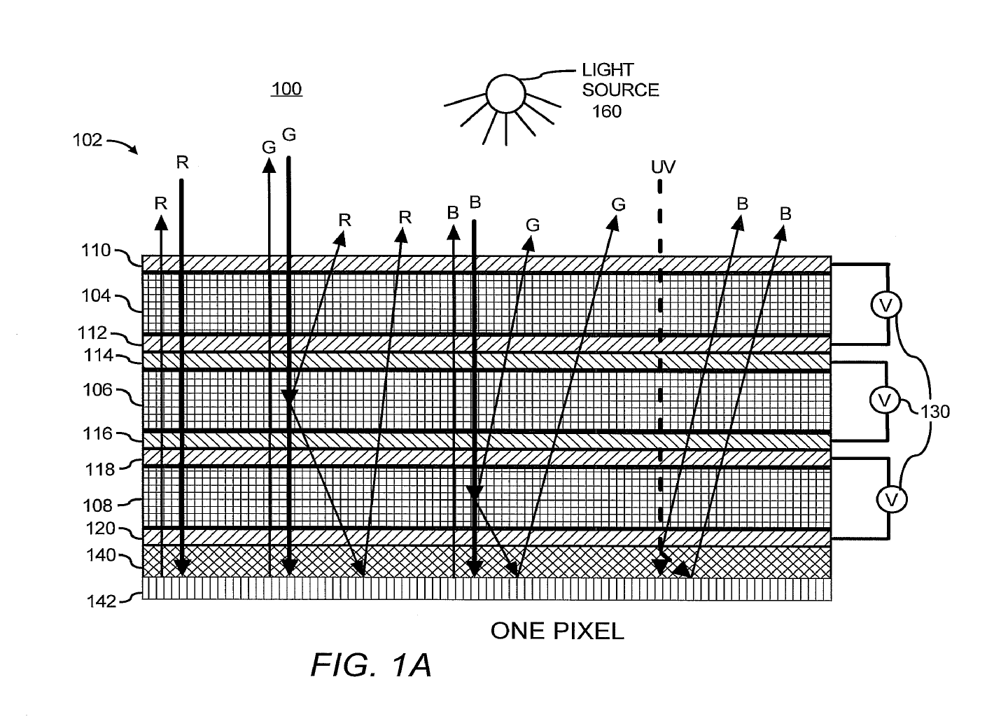

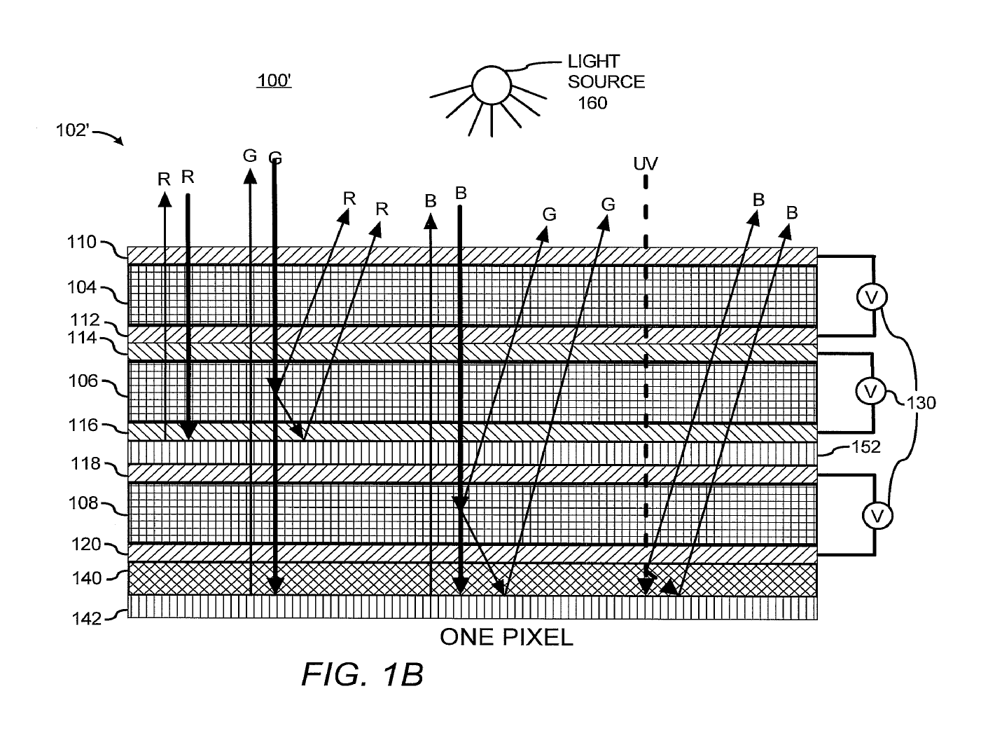

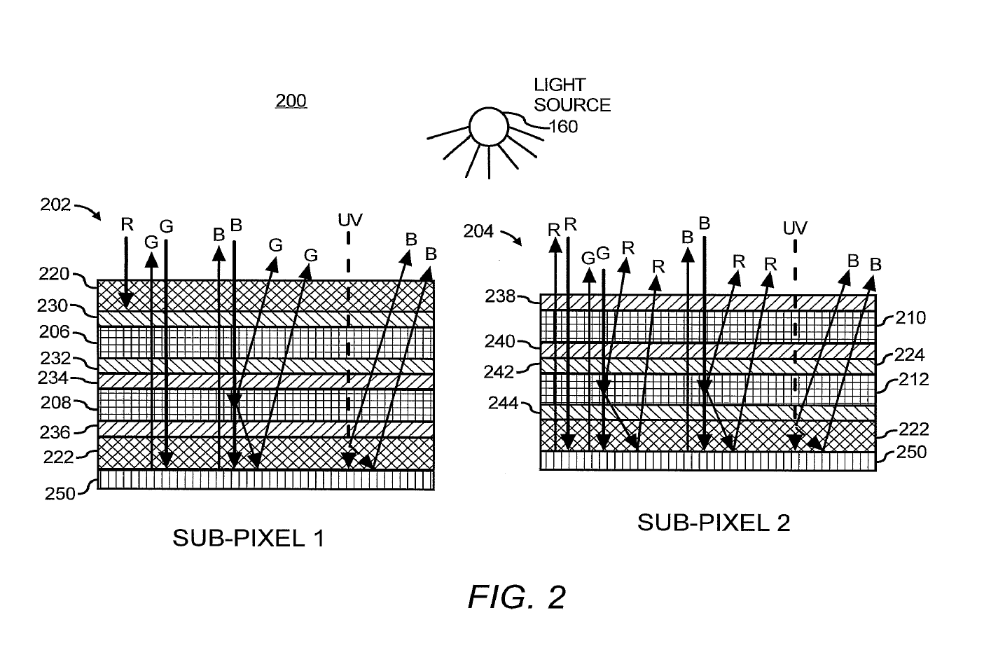

In an embodiment of the present invention, a reflective display device is provided with luminescent materials and a specific layer architecture to more efficiently use incident light and thereby display an image containing greater brightness, more saturated colors, and better contrast as compared with conventional reflective display devices. A reflective display device is a non-emissive device in which ambient light for viewing the displayed information is reflected from the display back to the viewer rather than light from behind the display being transmitted through the display. It will be understood that, for purposes of illustration, the various layers shown in FIGS. 1A, 1B, and 2 have been drawn not necessarily to scale.

FIG. 1A shows a diagram of a pixel component 102 of a display device 100, according to an embodiment of the invention. It should be understood that the display device 100 depicted in FIG. 1A may include additional components and that some of the components described herein may be removed and/or modified without departing from a scope of the display device 100.

The pixel component 102 comprises one of a plurality of pixel components 102 that the display device 100 may include for generating and displaying an image. As such, the description of the pixel component 102 may be applicable to the other plurality of pixel components.

As shown, the pixel component 102 includes a first guest-host layer 104, a second guest-host layer 106, and a third guest-host layer 108, which are arranged in a stack with respect to each other. The pixel component 102 further includes a plurality of electrode layers denoted as electrode layers 110, 112, 114, 116, 118, and 120. Each of the electrode layers 110-120 is disposed on top and bottom surfaces of each of the guest-host layers 104-108, such that each of the guest-host layers 104-108 is sandwiched between a pair of respective electrode layers 110-120. More particularly, the first guest-host layer 104 is positioned between electrode layers 110 and 112, the second guest-host layer 106 is positioned between electrode layers 114 and 116, and the third guest-host layer 108 is positioned between the electrode layer 118 and the electrode layer 120. Although not explicitly shown, other layers, such as thin LC alignment layers, may be provided between the guest-host layers 104-108.

Each of the guest-host layers 104-108 is configured to selectively have one of a plurality of states. Thus, in a first example, each of the guest-host layers 104-108 is configured to be in a first state when an electrical field is applied across their respective electrode layers 110-120 and to be in a second state when an electrical field is not applied across their respective electrode layers or vice versa. In one of the first state and the second state, each of the guest-host layers 104-108 is configured to absorb incident light in a different specified wavelength band, for instance, as denoted by the arrows in FIG. 1A. For example, the first guest-host layer 104 may be configured to absorb light in a first specified wavelength band, the second guest-host layer 106 may be configured to absorb light in a second specified wavelength band, and the third guest-host layer 108 may be configured to absorb light in a third specified wavelength band.

In a second example, the guest-host layers 104-108 may comprise bistable devices configured to retain their states following application and removal of an electrical field. In this regard, the guest-host layers 104-108 may remain in a first state after application and removal of the electrical field and may remain in a second state after application and removal of another electrical field.

In any of the plurality of states, the first guest-host layer 104 (first means of modulating the light in a first specified wavelength band) is configured to allow light in the wavelength bands outside of the first specified wavelength band to pass through the first guest-host layer 104. In addition, the second guest-host layer 106 (second means of modulating the light in a second specified wavelength band) is configured to allow light in the wavelength bands outside of the second specified wavelength band to pass through the second guest-host layer 106. Likewise, the third guest-host layer 108 (third means of modulating the light in a third specified wavelength band) is configured to allow light in the wavelength bands outside of the third specified wavelength band to pass through the third guest-host layer 108.

In each of the second states, the guest-host layers 104-108 are configured to allow substantially all of the light in all of the wavelength bands to pass therethrough. Thus, for instance, the characteristics of an image displayed on the pixel component 102 may be varied based upon which of the electrode layer pairs 110-120 are provided with an electric field.

According to an embodiment, the second guest-host layer 106 and the third guest-host layer 108 are further configured to convert light that is absorbed in the specified wavelength band to another specified wavelength band. More particularly, the second guest-host layer 106 and the third guest-host layer 108 include a luminescent material, such as, a dichroic dye, a pleochroic dye, acicular dichroic particles, etc., configured to selectively absorb light in one of the specified wavelength bands and to convert the absorbed light to at least one other specified wavelength band. For example, the second guest-host layer 106 is configured to absorb light in a second specified wavelength band and to convert the absorbed light to at least a portion of the first specified wavelength band. Likewise, the third guest-host layer 108 is configured to absorb light in a third specified wavelength band and to selectively convert the absorbed light to at least a portion of the second specified wavelength band.

The luminescent material as a guest absorber may be a material that either up-converts or down-converts light. The term, “up-convert” means converting light in a longer wavelength band to a shorter wavelength band, such as red to green or green to blue, and the term, “down-convert” means converting light from a shorter wavelength band to a longer wavelength band, such as blue to green or green to red. In another embodiment, a material that down-converts red to infrared (IR) may be used.

According to an example, one or more of the guest-host layers 104-108 comprises a nematic liquid crystal (LC). A nematic LC with positive dielectric anisotropy includes a number of rod-like molecules having electric dipole moments and thus may be aligned along the direction of an electric field. A nematic LC with negative dielectric anisotropy includes a number of rod-like molecules having electric dipole moments and thus may be aligned along a direction orthogonal to the electric field. According to another example, one or more of the guest-host layers 104-108 comprises smectic LCs, which also have orientational order and may be aligned in an electric field, but also have positional order.

A dichroic dye molecule that absorbs the component of light in a particular wavelength band and that has its electric field vector oriented along one axis, defined by the absorption dipole of the dye molecule, but not along other directions, may be placed in the LC. Thus, the dye molecules are the guest in the LC host, and the LC host may then be used to orient the dye molecules.

For example, to put the guest-host layers 104-108 with LCs that have a positive dielectric anisotropy into a primarily transparent state, an electric field may be applied to the guest-host layers 104-108 to orient the absorption dipoles perpendicular to the layers 104-108. To put the guest-host layers 104-108 with LCs that have a positive dielectric anisotropy into a primarily absorbing state, alignment layers (not shown) are configured to align the LCs in the plane of the electro-optic layers 104-108 in the absence of an electric field, which may be achieved through use of a rubbed polyimide layer, for instance. By way of example, when the pixel component 102 is operated to display colors other than blue, the third guest-host layer 108 may be configured to absorb light in the wavelength band that is equivalent to the color blue by controlling the LC to orient the blue absorption dipoles to be planar with the third guest-host layer 108. In addition, the third guest-host layer 108 may convert the absorbed blue light to a wavelength band that is equivalent to the color green. The third guest-host layer 108 may thus contain a blue absorbing pleochroic dye that emits the color green.

According to a particular embodiment, the first guest-host layer 104 is configured to selectively absorb light in the first specified wavelength band, in which the first specified wavelength band is equivalent to red light. In addition, the second guest-host layer 106 is configured to selectively absorb light in the second specified wavelength band and to emit light in the first specified wavelength band (red light), in which the second specified wavelength band is equivalent to green light. Moreover, the third guest-host layer 108 is configured to selectively absorb light in the third specified wavelength band, in which the third specified wavelength band is equivalent to blue and/or UV light.

In this embodiment, when a red color is desired from the pixel component 102, the first guest-host layer 104 may be placed in the transparent state to thus enable red light to pass through the first guest-host layer 104. In addition, the second guest-host layer 106 may be placed in the absorbing state to thus cause the luminescent dichroic dye materials contained therein to absorb the incident green light and to convert the light in the wavelength band that is equivalent to green light to a wavelength band that is equivalent to red light. In addition, the third guest-host layer 108 may be placed in the absorbing state to thus cause the luminescent dichroic dye materials contained therein to absorb the blue light and to convert the light in the wavelength band that is equivalent to blue light to a wavelength band that is equivalent to green light. In addition, the second guest-host layer 106 may absorb the green light from the third guest-host layer 108 and convert that light to red light to further enhance display of the red color from the pixel component 102.

Although the topmost guest-host layer 104 has been depicted as being configured to absorb the red color components of light, in various instances, the topmost guest-host layer 104 may be configured to absorb the blue color components of light. In addition, the order of the guest-host layers 104-108 may be reversed from that shown in FIG. 1A when a light source 160 is provided below the pixel component 102.

The pixel component 102 may further include a phosphorescent layer 140 and a reflector 142 disposed on the bottom of the stack of guest-host layers 104-108. The phosphorescent layer 140 is configured to absorb wavelengths of light that are equivalent to a deeper blue than the third guest-host layer 108 as well as wavelengths of light in the UV band. In addition, the phosphorescent layer 140 is configured to convert the absorbed light to a wavelength band that is equivalent to the color blue and the reflector 142 is configured to reflect light in all of the wavelength bands as shown in FIG. 1A.

With reference now to Table 1, there is shown an example of the settings for the guest-host layers 104-108 to achieve various desired colors. It should be understood that other colors, including gray scales, are attainable through various modifications in the guest-host layer 104-108 settings.

TABLE 1

| Active | | | | | | | Yel- | Ma- |
|---|---|---|---|---|---|---|---|---|
| Layer | Red | Green | Blue | White | Black | Cyan | low | genta |
| Red | 0 | 1 | 1 | 0 | 1 | 1 | 0 | .382 |
| absorb, | | | | | | | | |
| guest-host | | | | | | | | |
| layer 104 | | | | | | | | |
| Green → | 1 | 0 | 1 | 0 | 1 | 0 | 0.177 | 1 |
| Red, | | | | | | | | |
| guest-host | | | | | | | | |
| layer 106 | | | | | | | | |
| Blue → | 1 | 1 | 0 | 0 | 1 | 0 | 1 | 0 |
| Green, | | | | | | | | |
| guest-host | | | | | | | | |
| layer 108 | | | | | | | | |

In Table 1, the value “0” means transparent and the value “1” means fully absorbing. Yellow is defined as equal amounts of Red and Green (i.e., just absence of Blue), Cyan is defined as absence of Red, and Magenta is defined as absence of Green. It is assumed that there are perfect conversion efficiencies and ideal absorption spectra. The values given in Table 1 may be adjusted to produce the desired colors in cases where perfect conversion efficiencies and ideal absorption spectra are not obtained. In addition, uniform spectrum and photopic responses are assumed, and the possibility of incorporating a fixed UV-to-blue converting phosphorescent layer 140 is ignored for purposes of the examples provided in Table 1.

According to a further embodiment, some or all of the guest-host layers 104-108 may include dichroic absorbers or other luminescent materials to convert some of the available ultraviolet (UV) or IR light into visible light.

According to a further embodiment, the electrode layers 110-120 are each formed of a transparent electrically conducting material and/or formed of relatively thin strips of a non-transparent electrically conducting material. By way of example, the electrode layers 110-120 are formed of indium tin oxide. In addition, each of the electrode layer pairs 110-120 is controllable to selectively vary the electrical field generated across the respective guest-host layers 104-108. The electrode layers 110-120 are thus connected to a controllable power supply source 130. Thus, a controller (not shown) may control the power supply source 130 to selectively energize the electrode layer pairs 110-120 and thereby vary the states of the guest-host layers 104-108 and thus the color of an image displayed by the pixel component 102. The power supply source 130 and the controller may individually or in combination form a means for selectively controlling each of the first means, the second means, and the third means discussed above.

With reference now to FIG. 1B, there is shown a diagram of a pixel component 102′ of a display 100′, according to another embodiment of the invention. It should be understood that the display device 100′ depicted in FIG. 1B may include additional components and that some of the components described herein may be removed and/or modified without departing from a scope of the display device 100′.

The pixel component 102′ includes all of the elements that the pixel component 102 includes and thus, a description of the common elements is omitted with respect to the pixel component 102′. As illustrated, however, in FIG. 1B, the pixel component 102′ includes a reflector 152 positioned between the second guest-host layer 106 and the third guest-host layer 108. More particularly, the reflector 152 is positioned between a bottom electrode 116 of the second guest-host layer 106 and a top electrode 118 of the third guest-host layer 108. The reflector 152 is configured to reflect light in a specified wavelength band and to allow light in other wavelength bands to pass therethrough. As shown in FIG. 1B, the reflector 152 is configured to reflect red light.

In the embodiment depicted in FIG. 1B, almost all of the light in the first specified wavelength band may be reflected by the reflector 152. As such, the second guest-host layer 106 (second means of modulating the light in a first specified wavelength band) may be configured to absorb light in the second specified wavelength band (and in various instances, to also absorb light in the first wavelength band) and to transmit light in the third specified wavelength band. Likewise, almost all of the light in the second specified wavelength band may pass through the reflector 152. As such, the third guest-host layer 108 (third means of modulating the light in a third specified wavelength band) may be configured to absorb light in the third specified wavelength band (and in various instances, to also absorb light in the first and second wavelength bands).

According to other embodiments, other electro-optic effects that effectively allow one to switch an electro-optic layer from transparent in a particular wavelength band to absorbing in that wavelength band, with the absorbed light re-emitted in a different wavelength band may be used. For example, luminescent particles that are electrophoretically moved in and out of the field of view within an otherwise transparent pixel may be used in place of the electro-optic layers.

In the guest-host embodiments, the luminescent dichroic or pleochroic species may be dye molecules, orientable pigment particles, or asymmetric colloidal semiconducting particles. Luminescent nano-structured dichroic particles are other suitable materials. Some examples of pleochroic dyes with luminescent efficiencies greater than 75% may be found in the following papers, K. Binnemans, and D. Moors, J. Mater. Chem. Comm., 12, 3374 (2002); X. Zhang, et al., J. Mater. Chem., 14, 1901 (2004); X. Zhang, et al., J. Mater. Chem., 16, 736 (2006), the disclosures of which are incorporated by reference in their entireties.

Typically, dichroic species only absorb one polarization of light. However, there are a number of well known approaches for modulating both polarizations of light. For example, a twisted planar aligned LC configuration may be used to absorb both polarizations of light. This approach is particularly well suited to low birefringence liquid crystal hosts. A typical alternative is to use an untwisted planar configuration which will modulate one polarization, and then place a suitably aligned quarter waveplate (not shown) above reflector 142. If reflector 152 is included, a quarter wave plate may also be inserted above the reflector 152. The quarter waveplates effectively rotate the plane of polarization by 90 degrees for reflected light that makes two passes through them so that both polarizations are more completely absorbed by the guest-host layers 104-108. The use of quarter waveplates works well for the ambient light absorbed by each guest host layer 104-108 as it makes two passes through each of the dichroic layers. However the emitted layer may only pass once through the corresponding layer so that it will not be fully modulated. This will improve the brightness of the display, but at the expense of the contrast.

If the interlayer reflector 152 is not used, then only one quarter wave plate at the bottom of the stack is required. In this case, adjacent guest-host layers may be aligned so that the absorption dipoles of their guests are parallel in the absorbing state. In this embodiment, the luminescent light will be polarized parallel to the absorbing layer above the luminescent light and may be more completely absorbed.

A front-light may be used to augment ambient light in the designs of FIGS. 1A and 1B. In addition to reflective displays, a light source may be provided below the pixel component 102. In this example, the stacking order of the guest-host layers 104-108 will be reversed from the order shown in FIGS. 1A and 1B. In this regard, the display devices 100 and 200 may be backlit display devices.

In addition to improving brightness and/or decreasing the number of layers that are needed, the luminescent guest-host systems described here with certain embodiments may improve the viewing angle and/or contrast ratio of a display. The contrast ratio may be improved because of the increased efficiency with which the available light is used. This allows one to improve the black state by, for example, using thicker absorbing layers while maintaining an adequately bright white state. The viewing angle may be improved by tailoring the emission angles of the luminescent species. In addition, the viewing angle of the low absorption state in a standard guest/host device is compromised by the absorption of off-axis rays. Including luminescent species as discussed herein allows the recovery of some of that light.

The color gamut may be improved if the orientable luminescent species have narrow emission spectra, as is possible with acicular semiconducting nano-particles. Compressing the available light into narrow bands produces saturated colors, which may be used as a basis set to provide a larger color gamut volume. According to an embodiment, desirable choices for the emission wavelengths are bands close to Thornton's prime colors (approximately 445, 536, and 604 nm). (See William A. Thornton, “Luminosity and color-rendering capability of white light,” J. Opt. Soc. Am. 61(9):1155-1163, 1971; William A. Thornton, “Three-color visual response,” J. Opt. Soc. Am. 62(3):457-459 (1972); James A. Worthey, “Color rendering: asking the question,”Color Res. Appl. 28(6):403-412, 2003), the disclosures of which are hereby incorporated by reference in their entireties.

Turning now to FIG. 2, there is shown a diagram of sub-pixel components 202 and 204 of a display device 200, according to an embodiment of the invention. It should be understood that the display device 200 depicted in FIG. 2 may include additional components and that some of the components described herein may be removed and/or modified without departing from a scope of the display device 200. In addition, the sub-pixel components 202 and 204 contain many of the same elements as the pixel component 102 and thus, much of the discussion provided above with respect to the pixel component 102 is applicable to the sub-pixel components 202 and 204.

The sub-pixel components 202 and 204, together, form a pixel of the display device 200. In addition, the sub-pixel components 202 and 204 may comprise one of a plurality of sub-pixel components that the display device 200 may include for generating and displaying an image. As such, the description of the sub-pixel components 202 and 204 may be applicable to the other plurality of sub-pixel components. In addition, although a pixel component is depicted in FIG. 2 as being formed of two sub-pixel components 202 and 204, it should be understood that the pixel component may be formed of one or more additional sub-pixel components without departing from a scope of the sub-pixel components 202 and 204 depicted in FIG. 2. For instance, one or more additional sub-pixel components may be provided to provide further adjustments to the color balance achievable with the sub-pixel components 202 and 204.

As shown, each of the sub-pixel components 202 and 204 contains components arranged in a separate stack with respect to each other. The first sub-pixel component 202 is depicted as including a first guest-host layer 206 and a second guest-host layer 208. The second sub-pixel component 204 is depicted as including a first guest-host layer 210 and a second guest-host layer 212. Thus, in comparison with FIGS. 1A and 1B, the first and second sub-pixel components 202 and 204 depicted in FIG. 2 contain fewer guest-host layers, which may make fabrication of the first and second sub-pixel components 202 simpler.

As further shown in FIG. 2, the first sub-pixel component 202 includes a filter layer 220 that absorbs light within the first specified wavelength band, for instance, red color light. Alternatively, the filter layer 220 may be configured to up-convert red and/or IR light to UV, some of which will be directed into the sub-pixel component 202, where it may be down-converted back to blue or green. Although the filter layer 220 has been depicted as being positioned on top of the first guest-host layer 206, the filter layer 220 may also be positioned beneath the second guest-host layer 208.

In addition, the first guest-host layer 206, which includes a green color-absorbing dichroic dye as the guest in a liquid crystal, is positioned below the filter layer 220 and the second guest-host layer 208, which includes a blue color-absorbing luminescent pleochroic dye that converts blue or blue and UV light to a green color is positioned below the first guest-host layer 206.

The second sub-pixel component 204 is depicted as including a first guest-host layer 210, which includes a red color-absorbing dichroic dye as the guest in the liquid crystal. Positioned beneath the first guest-host layer 210 is a second guest-host layer 212, which includes a green and blue color-absorbing luminescent pleochroic dye that converts the green and blue colors to the red color.

The first sub-pixel component 202 and the second sub-pixel component 204 are depicted as including respective phosphorescent layers 222 and reflectors 250 positioned below the second guest-host layers 208 and 212. The phosphorescent layers 222 are configured to absorb wavelengths of light that are equivalent to a deeper blue than the second guest-host layers 208 and 212 as well as wavelengths of light in the UV band. In addition, the phosphorescent layers 222 are configured to convert the absorbed light to a wavelength band that is equivalent to the color blue and the reflectors 250 are configured to at least reflect light in a wavelength band that is equivalent to the color blue.

As with the pixel components 102 and 102′ depicted in FIGS. 1A and 1B, the sub-pixel components 202 and 204 also include electrode layers 230-244 positioned to selectively provide an electric field across the respective guest-host layers 206-212. An electric field may thus be selectively provided across respective ones of the guest-host layers 206-212 to thereby vary the states of the guest-host layers 206-212 and thus, the color of an image displayed by the sub-pixel components 202 and 204. As discussed above, the guest-host layers 206-212 may comprise bistable devices and may thus remain in a selected state following removal of the electrical field or the guest-host layers 206-212 may be configured to have one state when the electrical field is applied and to have another state when the electrical field is removed.

With reference now to Tables 2 and 3, there are shown examples of the settings for the guest-host layers 206-212 to achieve various desired colors. It should be understood that other colors, including gray scales, are attainable through various modifications in the guest-host layer 206-212 settings. Again, as in Table 1, the value “0” means transparent and the value “1” means fully absorbing in both Table 2 and Table 3.

TABLE 2
Sub-Pixel 1

| Active Layer | Green | Blue | Black | Cyan |
|---|---|---|---|---|
| Green absorb, | 0 | 1 | 1 | 0 |
| guest-host layer | | | | |
| 206 | | | | |
| Blue(+UV) →Green, | 1 | 0 | 1 | 0 |
| guest-host layer | | | | |
| 208 | | | | |

TABLE 3
Sub-Pixel 2

| Active Layer | Red | Black | Black | White |
|---|---|---|---|---|
| Red absorb, | 0 | 1 | 1 | 0 |
| guest-host layer | | | | |
| 210 | | | | |
| Blue + Green | 1 | 0 | 1 | 0 |
| (+UV) →Red, | | | | |
| guest-host layer | | | | |
| 212 | | | | |

According to an example, the sub-pixel components 202 and 204 are able to employ pixel architectures that incorporate dyes with larger stokes shifts (e.g., blue to red) as compared with the pixel component 102. In another example, LC molecules that absorb parts of the spectrum and transfer the energy to anisotropically-emitting dyes or pigments through processes such as Forster or Dexter exchange may be included.

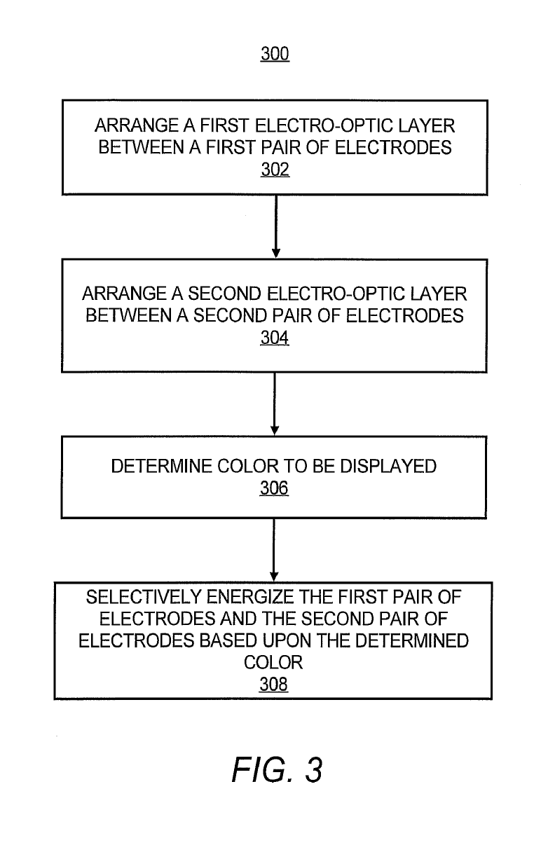

With reference now to FIG. 3, there is shown a flow diagram of a method 300 of displaying an image using pixel components 102, 102′, 202, 204 having luminescent properties, according to an embodiment. It should be apparent to those of ordinary skill in the art that the method 300 represents a generalized illustration and that other steps may be added or existing steps may be removed, modified or rearranged without departing from a scope of the method 300. In addition, the method 300 is described with particular reference to FIGS. 1A, 1B, and 2 by way of example and not of limitation.

At step 302, a first guest-host layer 104 is arranged between a first pair of electrodes 110 and 112. The first guest-host layer 104 is configured to selectively absorb light in a first specified wavelength band in a first state and to allow the light in the first specified wavelength band to pass therethrough in a second state. The first guest-host layer 104 is configured to let light in bands other than the first wavelength band to pass therethrough in both the first and second states. In addition, or alternatively, the first guest-host layer 104 may be configured to selectively vary the amount of light in the first specified wavelength band absorbed in one or more states between the first state and the second state, for instance, to vary the grayscale of the light in the first specified wavelength band emitted from the first guest-host layer 104.

At step 304, a second guest-host layer 106 is arranged between a second pair of electrodes 114 and 116 and in a stacked relationship with the first guest-host layer 104. The second guest-host layer 106 is configured to selectively absorb light in a second specified wavelength band and to convert the absorbed light to at least a portion of the first specified wavelength band in a first state and to allow the light in the first and second specified wavelength bands to pass therethrough in a second state. The second guest-host layer 106 is configured to let light in bands other than the first and second wavelength bands to pass therethrough in both the first and second states. In addition, or alternatively, the second guest-host layer 106 may be configured to selectively vary the amount of light in the second specified wavelength band absorbed in one or more states between the first state and the second state, for instance, to vary the grayscale of the light in the second specified wavelength band emitted from the second guest-host layer 106.

At step 306, a determination of which color the pixel component 102 or sub-pixel component 202, 204 is to display is made, for instance, by a processor or other controller (not shown) of the display device 100, 200. Based upon the color determination, a determination of which of the electrode layers 110-116 are to be provided with an electric field is made, as indicated at step 308. Examples of which of the electrode layers 110-116 of the pixel component 102 or sub-pixel component 202, 204 are to be provided with an electric field and thereby cause light in specified wavelength bands to be absorbed are described above with respect to the Tables 1-3.

In any regard, at step 308, the electrode layers 110-116 are selectively provided with an electric field in the desired guest-host layers 104 and/or 106, as discussed in greater detail herein above. The selected electrode layers 110-116 may be provided with the electric field until a change in the color of the display from the pixel component 102 or sub-pixel component 202, 204 is desired. In addition, in instances where the guest-host layers 104 and 106 comprise bistable devices, an electrical field may be applied and removed from the selected electrode layers 110-116 to cause the guest-host layers 104 and/or 106 to switch between a plurality of states.

Steps 302-308 may be repeated as needed to display a desired image or on a substantially continuous basis to display a series of images. In addition, the method 300 may include additional steps for employing one or more additional guest-host layers. In this regard, for instance, the method 300 may include a step of arranging a third guest-host layer 108 between a third pair of electrodes 118 and 120 in a stacked relationship with the first and second guest-host layers 104 and 106, as shown in FIGS. 1A and 1B. The third guest-host layer 108 is configured to selectively absorb light in a third specified wavelength band and to convert the absorbed light to at least a portion of the second specified wavelength band in a first state and to allow absorbed light in the first, second, and third wavelength bands to pass therethrough in a second state. In addition, or alternatively, the third guest-host layer 108 may be configured to selectively vary the amount of light in the third specified wavelength band absorbed in one or more states between the first state and the second state, for instance, to vary the grayscale of the light in the third specified wavelength band emitted from the third guest-host layer 108.

In addition, at step 306, the processor or controller may determine whether an electrical field is to be generated between the third pair of electrodes 118 and 120 and may supply the third pair of electrodes 118 and 120 with an electric field if needed to change the state of the third guest-host layer 108 to generate a desired color image. Moreover, in instances where the third guest-host layer 108 comprises a bistable device, the electrical field may be applied and removed from the electrode layers 118 and 120 to cause the third guest-host layer 108 to switch between a plurality of states.

The method 300 may also include one or more steps for providing a reflector 152 between the second and third guest-host layers 106 and 108 as shown in FIG. 1B and for providing a phosphorescent layer 140 on the pixel component 102 or sub-pixel components 202 and 204 as shown in FIGS. 1A, 1B, and 2.

The method 300 may further be concurrently applied on multiple sub-pixel components 202 and 204, for instance, as shown in FIG. 2.

Some of the operations set forth in the method 300 may be contained as utilities, programs, or subprograms, in any desired computer accessible medium. In addition, the method 300 may be embodied by computer programs, which may exist in a variety of forms both active and inactive. For example, they may exist as software program(s) comprised of program instructions in source code, object code, executable code or other formats. Any of the above may be embodied on a computer readable medium.

Exemplary computer readable storage devices include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims and their equivalents in which all terms are mean in their broadest reasonable sense unless otherwise indicated.

1. A display device comprising:
a plurality of pixel components, each of the pixel components having,
a first electro-optic layer positioned between a first pair of electrodes, wherein the first electro-optic layer is to selectively absorb light in a first specified wavelength;
a second electro-optic layer positioned between a second pair of electrodes, wherein the second electro-optic layer is to selectively absorb light in a second specified wavelength band and to convert the absorbed light in the second specified wavelength band to at least a portion of the first specified wavelength band,
wherein the first electro-optic layer and the second electro-optic layer are arranged in a stack with respect to each other.

2. The display device of claim 1, further comprising:
a third electro-optic layer positioned between a third pair of electrodes, wherein the third electro-optic layer is to selectively absorb light in a third specified wavelength band and to selectively convert the light absorbed in the third specified wavelength band to at least a portion of the second specified wavelength band, and wherein the third electro-optic layer is arranged in the stack with the first electro-optic layer and the second electro-optic layer.

3. The display device of claim 2, wherein the first specified wavelength band is equivalent to a red color, the second specified wavelength band is equivalent to a green color, and the third specified wavelength band is equivalent to a blue color, and wherein the second electro-optic layer and the third electro-optic layer include a luminescent material to selectively absorb light in one of the specified wavelength bands and to convert light to at least a portion of another specified wavelength band.

4. The display device of claim 1, further comprising:
a phosphorescent layer disposed on a bottom of the stack.

5. The display device of claim 1, further comprising:
a reflector positioned between the second electro-optic layer and the third electro-optic layer, wherein the reflector is to reflect light within the first specified wavelength band and to transmit light of other wavelength bands that are outside the first specified wavelength band.

6. The display device of claim 1, wherein at least one of the plurality of pixel components comprises a plurality of sub-pixel components, wherein each of the plurality of sub-pixel components is arranged in a separate stack with respect to the other plurality of sub-pixel components.

7. The display device of claim 6, wherein at least one of the plurality of sub-pixel components has a filter layer that absorbs light within the first specified wavelength band.

8. The display device of claim 1, wherein the light travels from a direction extending from the first electro-optic layer to the second electro-optic layer.

9. The display device of claim 1, wherein the first electro-optic layer and the second electro-optic layer comprise a guest-host material.

10. A method of displaying an image using a plurality of pixel components on a display device, the method comprising:
arranging a first electro-optic layer between a first pair of electrodes, wherein the first electro-optic layer is to selectively have a first state and a second state;
arranging a second electro-optic layer between a second pair of electrodes, wherein the second electro-optic layer is to selectively have a first state and a second state, wherein the second electro-optic layer is to selectively absorb light in a second specified wavelength band and to convert the absorbed light to at least a portion of the first specified wavelength band in a first state and to allow the light in the first and second specified wavelength bands to pass therethrough in a second state;
determining settings for the first pair of electrodes and the second pair of electrodes that generate a desired color; and
selectively energizing the first pair of electrodes and the second pair of electrodes based upon the determined settings.

11. The method of claim 10, further comprising:
arranging a third electro-optic layer between a third pair of electrodes, wherein the third electro-optic layer is to selectively have a first state and a second state, wherein the third electro-optic layer is to selectively absorb light in a third specified wavelength band and to convert the absorbed light to at least a portion of the second specified wavelength band in a first state and to allow absorbed light in the first, second, and third wavelength bands to pass therethrough in a second state;
wherein determining settings further comprises determining settings for the first pair of electrodes, the second pair of electrodes, and the third pair of electrodes that generate a desired color; and
wherein selectively energizing further comprises selectively energizing the first pair of electrodes, the second pair of electrodes, and the third pair of electrodes based upon the determined settings.

12. The method of claim 11, further comprising:
arranging a reflector between the second electro-optic layer and the third electro-optic layer, wherein the reflector is to reflect light within the first specified wavelength band and to transmit light of other wavelength bands that are outside the first specified wavelength band.

13. The method of claim 12, wherein the first specified wavelength band is equivalent to a red color, the second specified wavelength band is equivalent to a green color, and the third specified wavelength band is equivalent to a blue color, and wherein the second electro-optic layer and the third electro-optic layer include a luminescent material to selectively absorb light in one of the specified wavelength bands and to convert light to at least a portion of another specified wavelength band.

14. The method of claim 10, wherein the first electro-optic layer and the second electro-optic layer are arranged as a first sub-pixel component, said method further comprising:
arranging a second sub-pixel component adjacent to the first sub-pixel component, said second sub-pixel component having a first electro-optic layer positioned between a first pair of electrodes and a second electro-optic layer positioned between a second pair of electrodes;
wherein determining settings further comprises determining respective settings for the first sub-pixel component and the second sub-pixel component; and
wherein selectively energizing further comprises selectively energizing the first pair of electrodes and the second pair of electrodes of the first sub-pixel component and the second sub-pixel component based upon the determined settings.

15. A display device comprising:
a plurality of pixel components, each of the pixel components having,
first means for modulating light in a first specified wavelength band;
second means for modulating and converting light in a second specified wavelength band and to selectively convert the light absorbed in the second specified wavelength band to at least a portion of the first specified wavelength band in the first state, wherein the first means and the second means are arranged in a stacked relationship with respect to each other; and
means for selectively controlling each of the first means and the second means to selectively control a color of light emitted from each of the pixel components.
